(19) United States
(12) Patent Application Publication
(10) Pub. No.: US 2003/0219587 A1
(43) Pub. Date: Nov. 27, 2003

(54) Microporous, mixed polymer phase membrane

(76) Inventor: Richard W. Pekala, Corvallis, OR (US)

Correspondence Address: STOEL RIVES LLP, 900 SW FIFTH AVENUE, SUITE 2600, PORTLAND, OR, 97204, US

(21) Appl. No.: 10/439,723

(22) Filed: May 16, 2003

Related U.S. Application Data
(60) Provisional application No. 60/383,505, filed on May 24, 2002.

(51) Int. Cl. B32B 3/26

(52) U.S. Cl. 428/304.4

(57) ABSTRACT

A freestanding, microporous membrane includes a mixed polymer phase matrix having a first polymeric phase comprising a polyolefin interconnected with a second polymeric phase comprising a fibrillated fluoropolymer. A siliceous material is dispersed throughout the mixed polymer phase matrix. A method of forming the membrane of the present invention involves combining a siliceous material, a fluoropolymer capable of processing-induced fibrillation, and a polyolefin to form a mixture and subjecting the mixture to sufficient shear force during processing and extruding to effect fibrillation of the fluoropolymer and thereby form the interconnected mixed polymer phase matrix. The membrane is useful in a variety of products, including labels (printed and unprinted) and separators in energy storage devices, such as batteries, capacitors, and fuel cells.

### RELATED APPLICATION

This application claims priority from U.S. provisional patent application No. 60/383,505, filed May 24, 2002.

### COPYRIGHT NOTICE

©2003 Amtek Research International LLC. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention relates to a freestanding, microporous mixed polymer phase membrane and its formation and use.

### BACKGROUND OF THE INVENTION

U.S. Pat. No. 3,351,495 to Larsen et al. (1967) describes a battery separator comprising a microporous sheet including very high molecular weight polyolefin and an inert filler material, such as a dry, finely divided silica. Silica is included in the battery separator for two reasons: (1) it introduces some porosity into the microporous sheet, and (2) it improves the wettability of the polymeric material utilized to fabricate the sheet. Because silica is highly absorbent, it can absorb a substantial quantity of an aqueous or organic liquid while remaining free flowing. Consequently, the battery separator is formed by loading silica with a liquid of choice, e.g., oil or plasticizer, and then blending the mixture with the very high molecular weight polyolefin. Subsequently, the mixture is extruded and calendered into a plasticizer-filled sheet. The majority of the plasticizer is then removed from the sheet to impart porosity to the resultant separator.

U.S. Pat. No. 4,861,644 to Young et al. (1989) describes the formation and use of a printed microporous material comprising a matrix of ultrahigh molecular weight polyolefin (“UHMWPO”) and finely divided, water-insoluble siliceous filler. The resulting microporous substrate exhibited rapid drying capabilities, increased clarity of the printed image, and the ability to accept a wide variety of printing inks.

U.S. Pat. No. 5,196,262 to Schwarz et al. (1992) and U.S. Pat. No. 5,126,219 to Howard et al. (1993) describe a battery separator including UHMWPO and silica. Because the molecular chain entanglement of the UHMWPO provides sufficient mechanical integrity to form a microporous web having freestanding characteristics, these separators exhibit excellent operational characteristics. However, during the lifetime of the battery, the electrolyte can degrade the separator by oxidizing the UHMWPO, resulting in battery failure.

It has been recognized that, when subjected to shear forces, small particles of certain polymeric materials, e.g., perfluorinated polymers such as PTFE, will form fibrils of microscopic size. Using this knowledge, Ree et al. obtained in the late 1970s U.S. Pat. No. 4,153,661 which describes a polytetraflurorethylene (“PTFE”) composite sheet for use as an electronic insulator, a battery separator, and/or a semipermeable membrane for use in separation science. Formation of the tough, attractive, and extremely pliable film involved intensive mixing of the PTFE and lubricant mixture sufficient to cause the PTFE fibrils to fibrillate and form a sheet.

U.S. Pat. No. 4,810,381 to Hagen et al. (1989) describing a composite chromatographic article comprising a PTFE fibril matrix and a non-swellable absorptive particle, e.g., silica, enmeshed in the fibril matrix. The resulting sheet was used in the field of chromatographic analysis, which includes separating and analyzing mixtures of solutions by selective absorption.

In the late 1990s, the above-identified teachings from the fields of separation science and chromatographic analysis were used to formulate a battery separator comprising PTFE and precipitated silica. As described in U.S. Pat. No. 5,009,971 to Johnson et al. (1990), such a battery separator was used in a recombinant lead acid battery. The resulting sheet exhibited increased mechanical integrity and puncture resistance such that it could be wrapped around an electrode. However commercial manufacture of the separator was prohibitively expensive because of the high cost of PTFE and the inability to develop a continuous manufacturing process.

It is therefore desirable to produce a cost-effective microporous membrane that includes a polyolefin and a fibrillated fluoropolymer such that the resulting membrane can be used as a highly oxidation-resistant separator or as a synthetic printing sheet with security features.

### SUMMARY OF THE INVENTION

An object of the present invention is, therefore, to cost-effectively form a freestanding, microporous membrane including a polyolefin and a fibrillated fluoropolymer.

The freestanding, microporous membrane of the present invention includes a mixed polymer phase matrix having a first polymeric phase including a polyolefin and a second polymeric phase including a fibrillated fluoropolymer, e.g., PTFE. Unlike prior art microporous membranes, the first and second polymeric phases are interconnected such that they at least partially interpenetrate each other. A siliceous material is dispersed throughout the mixed polymer phase matrix.

The method of forming the freestanding, microporous membrane of the present invention involves forming a mixture by combining a siliceous material, a fluoropolymer capable of processing-induced fibrillation, and a polyolefin. During processing and extrusion, the mixture is subjected to sufficient shear force to effect fibrillation of the fluoropolymer and to form an interconnected mixed polymer phase matrix composed of a polyolefin and a fibrillated fluoropolymer. The resulting microporous membrane includes portions of the siliceous material dispersed throughout the mixed polymer phase matrix. One advantage of this method as compared to prior art methods is its ability to be carried out as a continuous process with in situ fibrillation, permitting the manufacture of commercial-scale quantities of the freestanding, microporous membrane.

The freestanding, microporous membrane of the present invention is useful in a variety of products, including labels (printed and unprinted) and separators in energy storage devices, such as batteries, capacitors, and fuel cells. When used as a battery separator, the mixed polymer phase matrix provides improved mechanical integrity during battery operation because the interconnectivity of the polyolefin phase and the fibrillated fluoropolymer phase ensures that the membrane substantially retains its form during battery operation despite electrolyte-induced oxidation and degradation of the polyolefin phase of the matrix. When used as a label, the presence of the fibrillated fluoropolymer phase facilitates increased security and tamper-resistance because the presence (or absence) of the fluorine moiety in the membrane can be spectroscopically determined. For example, use of the membrane of the present invention as a driver's license or passport would provide increased security because forged identifications could be easily identified by spectroscopically scanning the driver's license or passport to verify that it contains the fluorine moiety present in the fluoropolymer phase portion of the dual polymer phase matrix.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a schematic diagram of the freestanding, microporous membrane of the present invention, which includes siliceous material dispersed throughout a mixed polymeric phase matrix including a first polymeric phase comprising a polyolefin and a second polymeric phase comprising a fibrillated fluoropolymer.

FIG. 2 is a scanning electron micrograph (SEM) showing a prior art freestanding, microporous membrane including a single polymer phase matrix comprising ultrahigh molecular weight polyethylene.

FIG. 3 is a scanning electron micrograph (SEM) showing the freestanding, microporous membrane of the present invention, which includes a polymeric matrix having a first polymeric phase comprising a polyolefin and a second polymeric phase comprising a fibrillated fluoropolymer.

### DETAILED DESCRIPTION OF PREFERRED EMBODIMENTS

As used herein, the term “membrane” includes webs, sheets, films, and tubes.

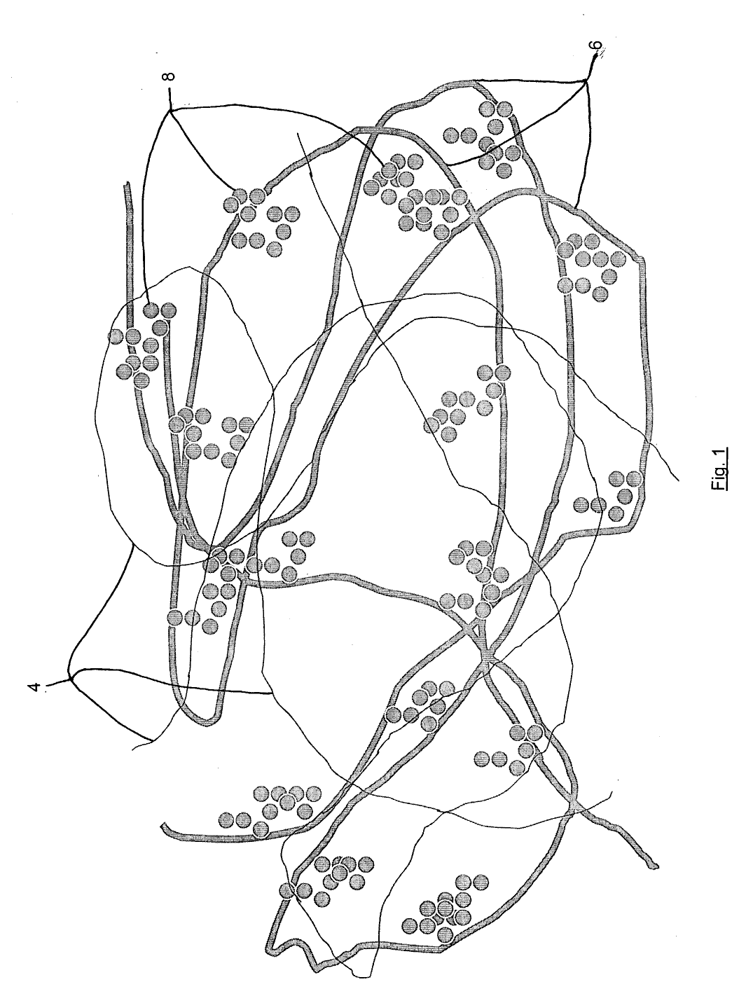

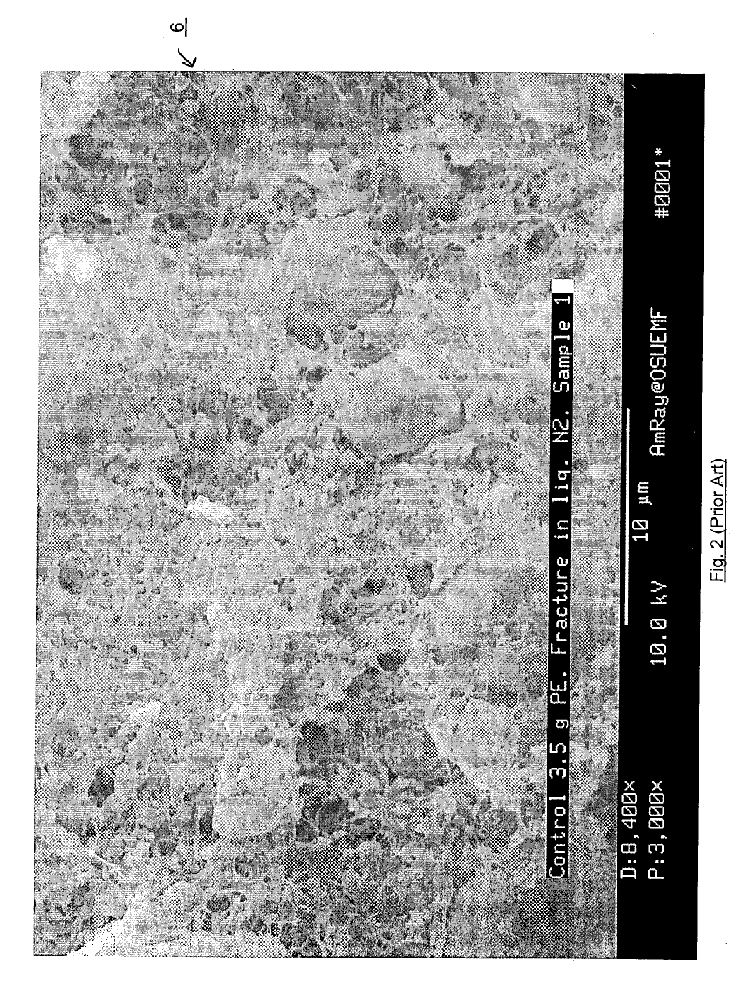

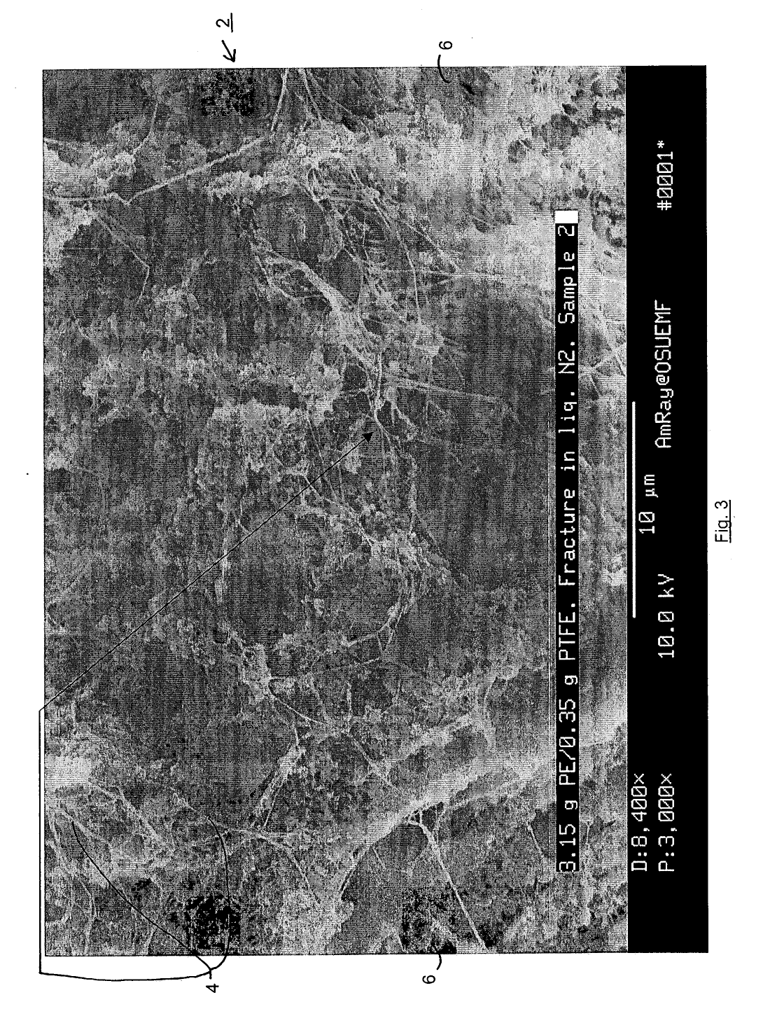

As shown in FIGS. 1 and 3, a freestanding, microporous membrane of the present invention includes a mixed polymer phase matrix 2 having a first polymeric phase comprising a polyolefin 6 interconnected with a second polymeric phase comprising a fibrillated fluoropolymer 4. The membrane further includes a siliceous material 8 dispersed throughout mixed polymer phase matrix 2. FIGS. 2 and 3 are, respectively, SEMs showing a prior art freestanding, microporous membrane having a single polymeric phase matrix comprising ultrahigh molecular weight polyethylene and the mixed polymer phase membrane of the present invention. Comparison of FIGS. 2 and 3 demonstrates the interconnectivity of the fibrillated fluoropolymer 4 with the first polymeric phase. FIG. 3 highlights the degree of fibrillation of fluoropolymer 4.

A preferred freestanding, microporous membrane of the present invention has a silica to polymer matrix weight ratio of between about 1:1 and about 10:1, more preferably between about 1.2:1 and about 5:1, and most preferably between about 1.5:1 and about 2.5:1. The fibrillated PTFE preferably comprises between about 1% by weight and about 10% by weight of the polymer matrix, more preferably between about 1% by weight and about 7% by weight, and most preferably between about 1% by weight and about 5% by weight. As is known to those skilled in the art, the membrane may also include minor amounts, usually less than about 5% by weight, of other materials typically used in processing, e.g., lubricants, organic extraction liquids, colorants, surfactants, antioxidants, ultraviolet light absorbers, reinforcing fibers, and water. The final membrane typically includes less than 20% of residual processing plasticizer.

Exemplary polyolefins for inclusion in the polymer matrix of the present invention include a crystalline homopolymer, a copolymer, or a blend thereof, each being obtained by polymerizing, for example, ethylene, propylene, 1-butene, 4-methyl-pentene-1,1-octene, or 1-hexene. Polyethylene (specifically an ultrahigh molecular weight polyethylene), and mixtures of polyethylene with the above polyolefins are preferred for inclusion in the membrane of the present invention.

Most preferably, an ultrahigh molecular weight polyolefin may be used. The polyolefin most preferably used is an ultrahigh molecular weight polyethylene (UHMWPE) having an intrinsic viscosity of at least 10 deciliter/gram, and preferably greater than about 14-18 deciliters/gram. It is not believed that there is an upper limit on intrinsic viscosity for the UHMWPEs usable in this invention. Current commercially available UHMWPEs have an upper limit of intrinsic viscosity of about 29 deciliters/gram. An exemplary commercially available UHMWPE is GUR 4150™, manufactured by Ticona.

The preferred fluoropolymer is PTFE. A variety of commercially available forms of PTFE may be used to prepare the freestanding, microporous membrane of the present invention, including TEFLON™ 601A and TEFLON™ K-10, both manufactured by E. I. du Pont de Nemours & Company, Fluon™ CD1, manufactured by ICI, and Dyneon 2025, manufactured by Hoechst. TEFLON™ K-10 is a free-flowing, white powder having an average particle size of about 500 microns.

Siliceous materials are those having surface silanol groups that can hydrogen bond to water. Exemplary siliceous materials for inclusion in the freestanding, microporous membrane of the present invention include silica, mica, montmorillonite, kaolinite, talc, diatomaceous earth, vermiculite, natural and synthetic zeolites, cement, calcium silicate, aluminum silicate, sodium aluminum silicate, aluminum polysilicate, alumina silica gels, and glass particles. Silica and the clays are the preferred siliceous particles. Of the silica particles, precipitated silica, silica gel, and fumed silica are preferred. Precipitated silica is most preferred.

Most types of commercially available precipitated silica are available as powders with the as-received individual particles having diameters in a range of approximately 5-50 micrometers. A silica particle is comprised of multiple interconnected silica aggregates, each of which has a diameter of about 0.1 to about 0.2 micrometer. Each individual silica aggregate is comprised of multiple covalently bonded primary particles, each of which has a diameter of about 20 nanometers. Silica particles derive their porosity from the interstices between and within silica aggregates. The degree of hydrogen and/or covalent bonding between silica aggregates determines the friability of the commercially available precipitated silica. The amount of hydrogen and/or covalent bonding between silica aggregates can be influenced by the precipitation and drying processes used to manufacture the commercially available precipitated silica. The siliceous material for use in the present invention may be in the form of particles, aggregates, primary particles, or a combination thereof. An exemplary commercially available precipitated silica is Hi-Sil SBG™, manufactured by PPG Industries.

The preferred plasticizer used in forming the membrane is a nonevaporative liquid having a boiling point higher than the processing temperature. The plasticizer is removed from the finished sheet by solvent extraction. Exemplary plasticizers for inclusion in the freestanding, microporous membrane of the present invention include organic esters such as the sebacates, stearates, adipates, phthalates, and citrates; epoxy compounds such as epoxidized vegetable oil; phosphate esters such as tricresyl phosphate; natural oils such as tall oil and linseed oil; and hydrocarbon oils, such as petroleum. Hydrocarbon oils are the most preferred plasticizer. Examples of commercially available petroleum hydrocarbon oils include Shellflex™ 412 oil, Shellflex™ 371 oil, and Shellflex™ 3681 oil, all of which are manufactured by Shell Oil Co.

The extraction solvent used to remove the plasticizer from the extruded web can be any material that is in liquid form at room temperature and that can dissolve the specific plasticizer employed. When the plasticizer is a petroleum hydrocarbon oil, exemplary preferred extraction solvents include chlorinated hydrocarbons, such as trichloroethylene, 1,1,1-trichloroethane, methylene chloride, perchloroethylene, tetrachloroethylene, and carbon tetrachloride; hydrocarbon solvents such as hexane, benzene, petroleum ether, toluene, and cyclohexane; and chlorofluorocarbons such as trichlorotrifluoroethane.

This technology can be used to manufacture a microporous membrane having a porosity of between about 35% and about 80%.

The method of forming the freestanding, microporous membrane of the present invention involves combining a siliceous material, a fluoropolymer capable of processing-induced fibrillation, and a polyolefin to form a mixture. The mixture can then be subjected to mechanical shear blending forces sufficient to effect at least partial fibrillation of the fluoropolymer to form a mixture of a desired consistency. The consistency of the mixture may be controlled by the duration of the mechanical shear blending or the final torque reached by the mixing equipment. Typically, shear blending is conducted at a temperature lower than the melting or sintering temperatures of the polymeric materials. Typically, the higher the processing temperature, the faster fibrillation occurs. When PTFE is included in the membrane, temperatures of from about 25° C. to about 100° C. may be used during mixing. Mixing times will typically vary from about 0.5 minute to about 10 minutes to obtain partial fibrillation of the PTFE particles.

A suitable mixer is any mixer that can subject the mixture to sufficient shear forces to fibrillate the fluoropolymer at the desired processing temperature. Exemplary commercially available batch mixers include the Banbury mixer, the Mogul mixer, the C. W. Brabender Prep mixer, and C. W. Brabender sigma-blade mixer.

The microporous membrane of the present invention is then formed by extrusion of the mixture. The ingredients may be extruded through a sheet die or through an annular die, as appropriate based on the desired membrane thickness. Alternatively, the PTFE particles can be dispersed in a plasticizer that is injected into an extruder to effect fibrillation.

Example 1 illustrates the method by which the microporous, freestanding membrane of the present invention may be prepared. The operational parameters of the comparative sheet formed in Example 2 were evaluated and compared with those of the sheet formed in Example 1. The results of this comparison are in Table I.

### EXAMPLE 1

Ultrahigh molecular weight polyethylene (325 grams, GUR™ 4150, manufactured by Ticona), PTFE (25 grams, K-10™, manufactured by Dupont), precipitated silica (1235 grams, Hi-Sil® SBG, manufactured by PPG Industries, Inc.), antioxidant (4 grams, B215, manufactured by Ciba), and lubricant (4 grams, CZ-81, manufactured by Ferro) were blended together in a Littleford mixer.

While blending of the mixture continued, process oil (1796 grams, ShellFlex® 3681 manufactured by Shell Oil Co.) was added through a spray nozzle. The resultant mixture was then placed in a loss-in-weight feeder attached to a 27 mm twin screw extruder (manufactured by ENTEK Manufacturing Inc.) The mixture was fed into the extruder at a rate of approximately 5 kg/hr while a melt temperature of approximately 215° C. was maintained. Additional process oil was added in-line to adjust the oil content to about 67% by weight. The resultant melt was passed through a sheet die into a calendar in which the gap was used to control the extrudate thickness. The oil-filled sheet was subsequently extracted with trichloroethylene and dried to form a microporous sheet. The resultant sheet had a density of 0.50 g/cc with a residual oil content of 13.0% by weight. The silica-to-polymer weight ratio of the microporous sheet was about 3.5:1.

### EXAMPLE 2

A control specimen was produced as described in Example 1, except that the blend contained 350 grams of UHMWPE (GUR 4150; Ticona) and 0 grams of PTFE. The resultant sheet had a density of 0.52 g/cc with a residual oil content of 14.2% by weight. The silica-to-polymer weight ratio of the sheet was about 3.5:1.

The oxidation resistance of the sheets formed according to Examples 1 and 2 were evaluated as follows. Each sheet was cut in the cross-machine direction into 25 mm×125 mm strips that were individually dipped into isopropyl alcohol for less than 5 seconds and then rinsed with distilled water. The strips were then mounted in a fixture that was placed in a glass jar filled with a sulfuric acid/hydrogen peroxide mixture formed by combining 670 ml of H₂SO₄ having a specific gravity of 1.28, 80 ml of H₂SO₄ having a specific gravity of 1.84, and 250 ml of a 30 weight percent H₂O₂ solution. Five strips from each sheet were placed in jars containing 500 ml of the sulfuric acid/hydrogen peroxide mixture. Multiple jars were placed into an 80° C. water bath and removed after exposure times of 20 hours and 48 hours, respectively. After each exposure time, the strips were then removed and thoroughly rinsed with warm water.

Elongation of the wet strips was measured using an Instron machine, and the results were compared to a commercial battery separator (RhinoHide™ 30-6-640 XS, manufactured by Entek International LLC). It should be noted that the commercial separator contained carbon black as a colorant and had longitudinal ribs on one surface. Table I demonstrates that the sheet from Example 1 had superior oxidation resistance as compared to the commercial separator and the sheet containing no PTFE (Example 2).

TABLE I

| | Example | Example | Commercial |
|---|---|---|---|
| | 1 | 2 | Separator |
| % PTFE in | 7.1 | 0 | 0 |
| polymer matrix | | | |
| % XMD elongation | | | |
| loss | | | |
| initial | 515 | 499 | 653 |
| 20 hr perox exposure | 611 | 218 | 622 |
| 48 hr perox exposure | 422 | 5 | 134 |
| % XMD elongation | | | |
| loss | | | |
| 20 hr perox exposure | none | 56.3 | 4.8 |
| 48 hr perox exposure | 19.1 | 99 | 79.5 |
| Electrical resistance | 0.07 | 0.05 | 0.08 |
| (Ω-cm2/0.25 mm | | | |
| backweb) | | | |

One advantage of practicing this method as compared to prior art methods is its ability to be conducted as a continuous process with in situ fibrillation, permitting the manufacture of commercial-scale quantities of the freestanding, microporous membrane.

The resulting freestanding, microporous membrane of the present invention has a variety of uses, including labels (both printed and unprinted) and separators in energy storage devices, such as batteries, capacitors, and fuel cells. When used as a battery separator, the mixed polymer phase matrix of the membrane provides cost-effective improved mechanical integrity during battery operation because the interconnectivity of the polyolefin phase and the fibrillated fluoropolymer phase ensures that the membrane will substantially retain its form during battery operation despite electrolyte-induced oxidation and degradation of the polyolefin phase of the matrix. However, the amount of fibrillated fluoropolymer is relatively low such that the cost of the membrane is kept to a minimum.

An example of use of the membrane as a substrate on which is printed a label is as follows.

### EXAMPLE 3

A microporous sheet from Example 1 was passed through a Hewlett-Packard Color Laser Jet 4550 printer to produce a color image without distortion of the sheet or fusion to the toner roll. The presence of PTFE in the printed sheet was determined spectroscopically.

When used as a label, the presence of the fibrillated fluoropolymer phase facilitates increased security and tamper-resistance because the presence (or absence) of the fluorine moiety can be spectroscopically determined. For example, use of the membrane of the present invention as a printed substrate forming a driver's license or passport would provide increased security because forged identifications could be easily identified by scanning the driver's license or passport to verify that it contains the fluorine moiety present in the fluoropolymer phase portion of the dual polymer phase matrix.

It will be obvious to those having skill in the art that many changes may be made to the details of the above-described embodiments without departing from the underlying principles of the invention. The scope of the present invention should, therefore, be determined only by the following claims.

1. A freestanding, microporous membrane, comprising:
a polymer matrix including first and second polymeric phases, the first polymeric phase including a polyolefin and the second polymeric phase including a fibrillated fluoropolymer that at least partially interpenetrates the first polymeric phase; and
a siliceous material dispersed throughout the polymer matrix.

2. The membrane of claim 1, in which the polyolefin is selected from the group consisting essentially of a homopolymer, a copolymer, and a blend thereof, each being obtained by polymerizing a monomer selected from the group consisting essentially of ethylene, propylene, 1-butene, 4-methyl-pentene-1, 1-octene, and 1-hexene.

3. The membrane of claim 1, in which the polyolefin is ultrahigh molecular weight polyethylene.

4. The membrane of claim 1, in which the fibrillated fluoropolymer is polytetrafluoroethylene.

5. The membrane of claim 1, in which the siliceous material is selected from the group consisting essentially of precipitated silica, silica gel, fumed silica, mica, montmorillonite, kaolinite, talc, diatomaceous earth, vermiculite, natural and synthetic zeolites, cement, calcium silicate, aluminum silicate, sodium aluminum silicate, aluminum polysilicate, alumina silica gels, glass particles, and mixtures thereof.

6. The membrane of claim 1, in which the membrane forms a synthetic printing sheet.

7. The membrane of claim 1, in which the membrane forms a battery separator.

8. The membrane of claim 1, in which the membrane has a siliceous material to polymer matrix ratio of between about 1:1 and about 10:1.

9. The membrane of claim 1, in which the fibrillated fluoropolymer comprises between about 1% by weight and about 10% by weight of the polymer matrix.

10. A method of forming a freestanding, microporous membrane, comprising:
combining a siliceous material, a fluoropolymer capable of processing-induced fibrillation, and a polyolefin to form a mixture;
subjecting the mixture to sufficient shear force to effect fibrillation of the fluoropolymer and thereby form an interconnected mixed polymer phase matrix composed of fibrillated fluoropolymer and polyolefin, the mixed polymer phase matrix having portions of the siliceous material dispersed throughout.

11. The method of claim 10, in which the membrane forms a synthetic printing sheet.

12. The method of claim 10, in which the membrane forms a battery separator.

13. The method of claim 10, in which the formation of the freestanding, microporous membrane is performed in a continuous process such that the fibrillation of the fluoropolymer takes place in situ.

14. The method of claim 10, further comprising:
printing ink on at least a portion of the membrane.

15. The method of claim 10, in which the membrane has a siliceous material to polymer matrix ratio of between about 1:1 and about 10:1.

16. The method of claim 10, in which the fibrillated fluoropolymer comprises between about 1% by weight and about 10% by weight of the mixed polymer phase matrix.

17. In an energy storage device including a first electrode separated from a second electrode by a freestanding, microporous separator, the separator comprising:
a polymer matrix including first and second polymeric phases, the first polymeric phase including a polyolefin and the second polymeric phase including a fibrillated fluoropolymer that at least partially interpenetrates the first polymeric phase; and
a siliceous material dispersed throughout the polymer matrix.

18. The energy storage device of claim 17, in which the energy storage device is selected from the group consisting essentially of a battery, a capacitor, and a fuel cell.
